(19) United States
(12) Patent Application Publication
(10) Pub. No.: US 2002/0061419 A1
(43) Pub. Date: May 23, 2002

(54) Poly (phenylenevinylene) derivatives substituted with spirobifluorenyl group(s) and electroluminescent devices prepared using the same

(76) Inventors: Tae-Woo Woo, Taejon (KR); Hong You, Taejon (KR); Taek-Kyu Han, Taejon (KR); Dong-Jin Joo, Taejon (KR); Soon-Ki Kwon, Jinju City (KR); Yun-Hi Kim, Jinju City (KR); Dong-Cheol Shin, Jinju City (KR); Sang-Yun Jung, Jinju City (KR)

Correspondence Address: ABELMAN, FRAYNE & SCHWAB, Attorneys at Law, 150 East 42nd Street, New York, NY, 10017, US

(21) Appl. No.: 09/971,417

(22) Filed: Oct. 4, 2001

(30) Foreign Application Priority Data
Oct. 6, 2000 (KR) 2000-58930

(51) Int. Cl. H05B 33/14; C08G 61/02; C09K 11/06

(52) U.S. Cl. 428/690; 428/917; 313/504; 313/506; 257/40; 252/301.35; 526/281

(57) ABSTRACT

Disclosed is an organic electroluminescent polymer represented by the following Formula 1:

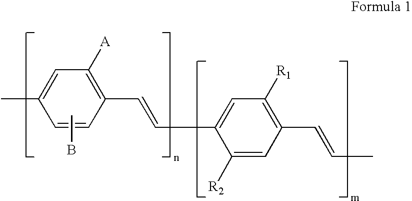

wherein both A and B are

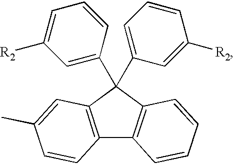

or any one of A and B is

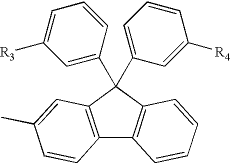

and the other is R₅; R₃, R₄ and R₅ are independently selected from the group consisting of hydrogen, phenoxy group substituted with C₁₋₂₀ alkyl group, C₁₋₂₀ alkoxy group, C₁₋₂₀ alkoxyphenyl group, C₁₋₂₀ alkyl group and C₃₋₂₁ ω-methoxy poly ethylene oxide group; m is an integer of 0 to 50,000; n is an integer of 1 to 100,000, proviso that n is greater than m. An electroluminescent device prepared using the electroluminescent polymer according to the present invention has an improved luminous efficiency and stability by solving problems associated with the heat generated during the driving of the device, and preventing deterioration of luminescence due to the π-stacking of polymers for Forming the organic film.

### BACKGROUND OF THE INVENTION

1. Field of the Invention

The present invention relates to an organic electroluminescent device (EL device) More particularly, the present invention relates to an organic electroluminescent polymer introducing a substituent capable of minimizing molecular interactions to a main chain of phenylene vinylene, thereby exhibiting excellent luminous properties, and an electroluminescent device using the same.

2. Description of the Related Art

Recently, due to rapid growth of the optical communications and multi-media industry, development of highly informed societies has been accelerated. In this regard, optoelectronic devices, which use conversion of photons to electrons, or conversion of electrons to photons, have become a core technology in the current information electronic industry. Such optoelectronic devices may be roughly divided into electroluminescence display devices, non-emissive devices and combinations thereof. Until now, non-emissive type devices have been mainly known in the relevant arts. However, the electroluminescence display devices, which are self-emissive type devices, do not need backlighting and have many advantages such as a short response time and excellent brightness. Accordingly, much attention is drawn to the electroluminescence display devices as next generation display devices.

Electroluminescence display devices are classified into inorganic luminescent devices and organic luminescent devices depending on materials forming a light emitting layer. Generally, the inorganic luminescent devices are formed via p-n conjugation of inorganic semiconductor such as GaN, ZnS and SiC, and are characterized by high efficiency, small size, long lifetime and low energy consumption. Therefore, they are applied to displays with a small area, light emitting diode lamps, semiconductor lasers and the like. However, EL devices made of inorganic material require a drive voltage of AC 200 V or more. Furthermore, it is difficult to manufacture large sized displays using them since vacuum deposition is involved during manufacturing processes, and to emit blue light with high efficiency. In order to solve such problems, methods for manufacturing electroluminescence display devices taking advantage of organic electroluminescence phenomenon have been reported (see, for example, Appl Phys. Letter., 51, p913 (1987) and Nature, 347, p539 (1990).

Organic electroluminescence (EL) refers to a phenomenon that when an electric field is applied to an organic material, electrons and holes are transported from cathode and anode, respectively, and combined together in the organic material to generate energy, which is released as light.

Such organic electroluminescence was first reported by Pope et al, in 1963. Also, in 1987, Tang et al. disclosed an electroluminescence device using a pigment having a π-conjugated structure, i.e., alumina-quinone, which has a multi-layered structure, quantum effect at 10 V or less of 1%, and a, brightness of 1000 cd/m², and thereafter much research and studies have been conducted thereon. The above-mentioned device has advantage in that, since synthesis is simple, various types of materials can be easily synthesized and color tuning is available. However, it was found to have problems of poor thermal stability when applying voltage thereto, Joule heat may be generated within the light emitting layer, which causes realignment of molecules and thereby, destruction of the device. Thus, these problems may cause reduced luminous efficiency and shorter life span of the device. To solve the problems encountered in the conventional techniques, electroluminescent devices using light emitting polymer may be employed.

FIG. 7 is a cross-sectional view illustrating a structure of a general organic electroluminescent device having a structure of substrate/anode/hole-transport layer/light emitting layer/electron-transport layer/cathode. In FIG. 7, a substrate 11 is shown to have an anode 12 formed thereon. On the upper side of the anode 12, a hole-transport layer 13, a light emitting layer 14, and an electron-transport layer 15 are formed in order. Here, the hole-transport layer 13, light emitting layer 14 and electron-transport layer 15 are organic thin films made of organic compounds. The principle of driving the organic electroluminescent device of the above structure is as follows.

When the anode 12 and cathode 16 are applied with voltage, holes injected from the anode 12 are transferred to the light emitting layer 14 via the hole-transport layer, while electrons injected from the cathode 16 are transferred to light emitting layer 14 via the electron-transport layer 15. In the region of light emitting layer 14, such carriers are recombined to produce excitons. These excitons fall to the ground state from the excited state, whereby the fluorescent molecules in the light emitting layer emit light to display an image.

The organic electroluminescent devices driven by the above-described principles are divided into organic electroluminescent devices using high molecular weight compound and organic electroluminescence using low molecular weight compound according to the molecular weight of materials for forming light emitting layers.

In general, when using low molecular weight materials in forming the organic film, since the materials are readily purified, impurities can be thoroughly removed so that the luminescent properties are superior. However, the low molecular weight materials have disadvantages that they cannot be applied by spin coating. Also, they suffer from the degradation or re-crystallization caused by heat generated during the driving of the device since heat resistances thereof are poor.

On the contrary, high molecular weight materials have two energy levels, which are separated into a conduction band and a valence band by overlap of wave functions of π-electrons existing in the main chain of the materials. Semiconductor properties of the high molecular weight materials are determined by the band gap energy corresponding to the difference between the energies of the two bands. Thus, when using high molecular weight materials in the electroluminescent device, display of a full range of colors is possible.

Such high molecular weight polymer is referred to as “π-conjugated polymer”. In 1990, an electroluminescent device using poly(p-phenylenevinylene), a polymer containing a conjugated double bond was suggested for the first time by Professor R. H. Friend et al of University of Cambridge, UK. Thereafter, studies using organic high molecular weight materials have been actively carried out. The electroluminescent polymers commonly applied to manufacture of electroluminescent devices are PPV derivatives in which 1 or 2 alkoxy groups, alkyl groups or aryl groups are substituted. High molecular weight materials show a heat resistance superior to low molecular materials. Also, since they are coatable by a spin coating method, they can be formed in a large surface. However, they are difficult to purify. Therefore, there may be deterioration of luminous properties due to impurities. For example, in case of precursor for PPV derivatives which are raw materials of representative polymeric light emitting diodes, sulphonium salts should be removed in order to obtain a perfect PPV derivative. However, the removal of the salts is difficult, and when formed into a thin layer, unreacted sulphonium salts are gradually eliminated, generating pin holes to cause non-uniformity of the film.

For the purpose of solving the above problems, U.S. Pat. Nos. 5,909,038 and 6,117,965 (Hwang et al.) disclose that green light emission efficiency can be improved by using a soluble poly(1,4-phenylenvinylene) (PPV) derivative in which two silyl groups are substituted in a light-emitting layer. Similarly, there have been reported various polyphenylenevinylene derivatives, polythiophene derivatives capable of improving processiblity and giving various colors by introducing an appropriate substituent. However, there are problems to be solved in association with the minimization of interaction between excitons released from two adjacent molecules. In order to solve these problems, if bulky side chains are introduced into the polymers, electrical conductivity is so lowered that light emission efficiency is reduced and drive voltage increases. Therefore, research has been conducted as to a side chain capable of minimizing the interaction between polymeric chains while providing proper level of electrical conductivity.

### SUMMARY OF THE INVENTION

Thus, the present inventors have conducted intensive researches and studies to solve the problems encountered in the prior art as described above. As a result, the present inventors have found organic electroluminescent polymers capable of minimizing the molecular interactions by providing PPV derivatives in which spirobifluorenyl group(s) is substituted, whereby can prevent deterioration due to heat generated during the driving of the light emitting devices.

Therefore, it is an object of the present invention to provide organic electroluminescent polymers capable of minimizing interactions between excitons, thereby exhibiting excellent light emitting efficiency.

It is another object of the present invention to provide organic electroluminescent polymers capable of preventing the deterioration caused by the heat generated during the driving of the light emitting device.

It is further object of the present invention to provide eletroluminescent devices prepared using the organic electroluminescent polymer according to the present invention as materials for forming an electroluminescent layer, a hole-transport layer or an electron-transport layer.

In order to achieve the above and other objects, the organic electroluminescent polymer according to the present invention is represented by the following Formula 1:

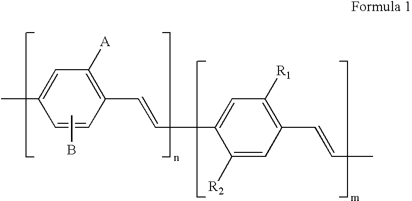

wherein both A and B are

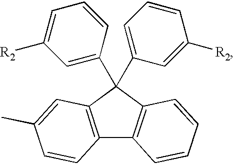

or any one of A and B is

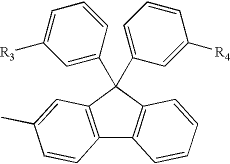

and the other is R₅; R₃, R₄ and R₅ are independently selected from the group consisting of hydrogen, phenoxy group substituted with C₁₋₂₀ alkyl group, C₁₋₁₂ alkoxy group, C₁₋₂₀ alkoxyphenyl group, C₁₋₂₀ alkyl group and C₃₋₂₁ ω-methoxy poly ethylene oxide group; m is an integer of 0 to 50,000; n is an integer of 1 to 100,000, with the proviso that n is greater than m.

### BRIEF DESCRIPTION OF THE DRAWINGS

The above objects, and other features and advantages of the present invention will become more apparent after a reading of the following detailed description when taken in conjunction with the drawings, in which:

FIG. 1 is a schematic view showing respective steps of the process for preparing the electroluminescent polymer represented by Formula 2 according to the present invention;

FIG. 2 is a schematic view showing respective steps of the process for preparing the electroluminescent copolymer represented by Formula 3 according to the present invention;

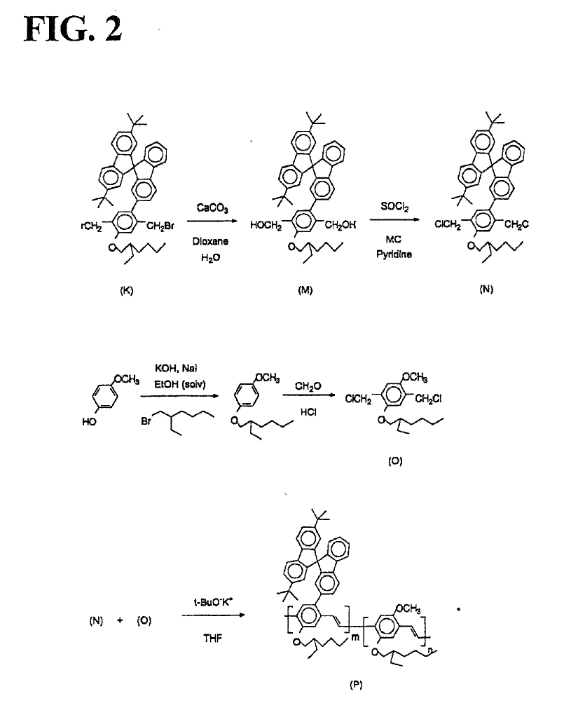

FIG. 3 is a view showing 1H-NMR Spectrum of the electroluminescent polymer represented by Formula 2 according to the present invention;

FIG. 4 is a view showing UV Absorption Spectrum and Photoluminescence (PL) Spectrum of the electroluminescent polymer represented by Formula 2 according to the present invention;

FIG. 5 is a view showing a thermal gravimetric analysis (TGA) curve of the electroluminescent polymer represented by Formula 2 according to the present invention;

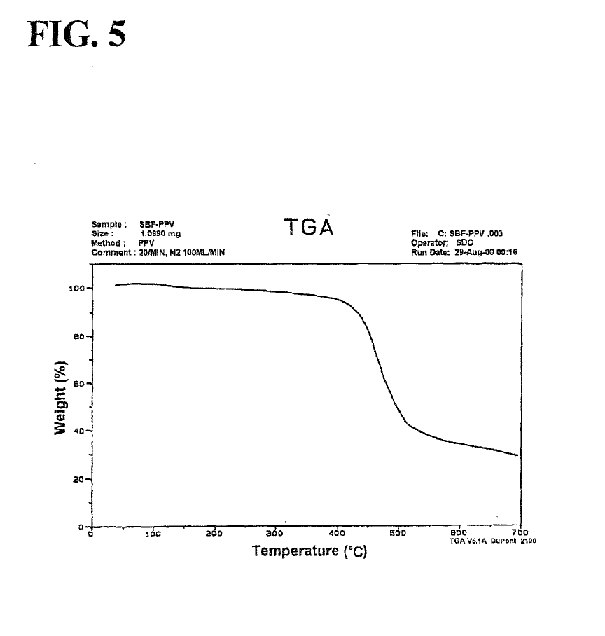

FIG. 6 is a view showing a differential scanning calorimetry (DSC) curve of the electroluminescent polymer represented by Formula 2 according to the present invention;

FIG. 7 is a view showing the structure of the general organic electroluminescent device having a structure of substrate/anode/hole-transport layer/light emitting layer/electron-transport layer/cathode;

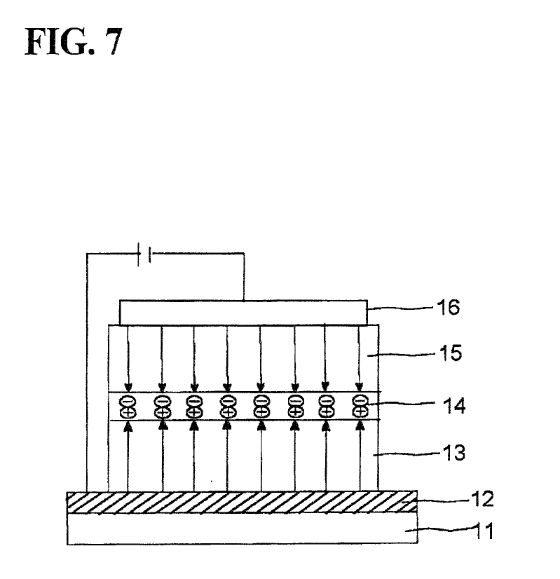

FIG. 8 is a view showing the structure of the organic electroluminescent device prepared as in Example 2 to determine electroluminous properties of the electroluminescent polymer represented by Formula 2;

FIG. 9 a view showing the structure of the organic electroluminescent device prepared as in Example 3 to determine electroluminous properties of the electroluminescent polymer represented by Formula 2;

FIG. 10 a view showing the structure of the organic electroluminescent device prepared as in Example 4 to determine electroluminous properties of the electroluminescent polymer represented by Formula 3;

FIG. 11 is a view showing an electroluminescence (EL) spectrum of the organic electroluminescent device in Example 2;

FIG. 12 is a view showing current-voltage curve of the organic electroluminescent device in Example 2;

FIG. 13 is a view showing brightness-voltage curve of the organic electroluminescent device in Example 2;

FIG. 14 is a view showing external quantum efficiency-voltage curve of the organic electroluminescent device in Example 2;

FIG. 15 is a view showing power efficiency-voltage curve and luminous efficiency-voltage curve of the organic electroluminescent device in Example 2;

FIG. 16 is a view showing an electroluminescence (EL) spectrum of the organic electroluminescent device in Example 3;

FIG. 17 is a view showing a current density-voltage curve of the organic electroluminescent device in Example 3;

FIG. 18 is a view showing a brightness-voltage curve of the organic electroluminescent device in Example 3; and

FIG. 19 is a view showing a power efficiency-voltage curve of the organic electroluminescent device in Example 3.

FIG. 20 is a view showing an electroluminescence (EL) spectrum of the organic electroluminescent device in Example 4;

FIG. 21 is a view showing current-voltage curve of the organic electroluminescent device in Example 4;

FIG. 22 is a view showing brightness-voltage curve of the organic electroluminescent device in Example 4;

FIG. 23 is a view showing external quantum efficiency-voltage curve of the organic electroluminescent device in Example 4;

FIG. 24 is a view showing power efficiency-voltage curve and luminous efficiency-voltage curve of the organic electroluminescent device in Example 4;

### DETAILED DESCRIPTION OF THE INVENTION

The present invention is described in detail below.

According to the present invention, there is provided an the organic electroluminescent polymer represented by the following Formula 1;

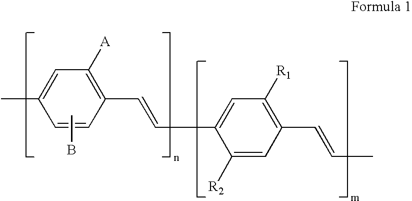

wherein both A and B are

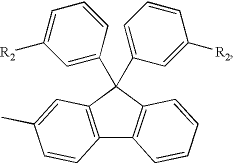

or any one of A and B is

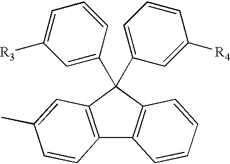

and the other is R₅; R₃, R₄ and R₅ are independently selected from the group consisting of hydrogen, phenoxy group substituted with C₁₋₂₀ alkyl group, C₁₋₂₀ alkoxy group, C1-20 alkoxyphenyl group, C₁₋₂₀ alkyl group and C₃₋₂₁ ω-methoxy poly ethylene oxide group; m is an integer of 0 to 50,000; n is an integer of 1 to 100,000, with the proviso that n is greater than m.

The organic electroluminescent polymer is used as materials for forming a light emitting layer, a hole-transport layer or an electron-transport layer disposed between a pair of electrodes in an electroluminescent device.

Since the polymer according to the present invention includes a substituent capable of providing steric hindrance as shown in the Formula 1, π-stacking between polymeric chains may be suppressed. When bulky substituents are introduced to polymer molecules as above, two- and three-dimensional interactions between polymer chains are suppressed. Accordingly, it may be prevented that excitons are quenched by the molecular interactions. As a result, it is possible to prepare organic electroluminescent devices using the electroluminescent polymer according to the present invention as light emitting materials and also, to attain a high light emitting efficiency.

As a specific example of the organic electroluminescent polymer according to the present invention represented by a following Formula 2 and 3.

Formula 2 conforms to Formula 1 wherein A is

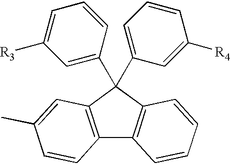

in which R₃ and R₄ are t-butyl group and B is 2-ethylhexyloxy group.

Formula 3 conforms to Formula 1 wherein A is

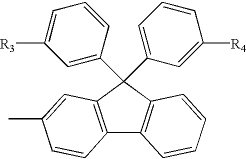

in which both R₃ and R₄ are t-butyl group and B is 2-ethylhexyloxy group, R₁ is methoxy group and R₂ is 2-ethylhexyloxy group.

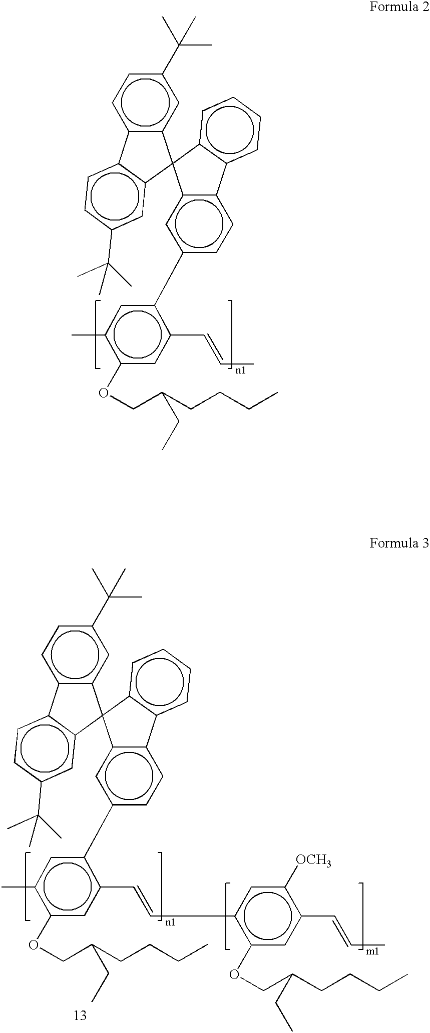

wherein m₁ is an integer of 0 to 50,000 and n₁ is an integer of 1 to 100,000, with the proviso that n₁ is greater than m₁.

An exemplary method for preparing the above organic electroluminescent polymer according to the present invention is as follows. Monomers for polymerization are synthesized via Bromination, Grignard reaction, Esterification reaction, Alkylation, Suzuki coupling reaction, NBS Bromination. Then, the monomers are polymerized to produce PPV derivatives in which spirobifluorenyl group(s) is substituted in accordance with Gilch method using a strong base such as potassium-t-butoxide. The polymers may have number average molecular weights of 500 to 10,000,000 and a molecular weight distribution of 1 to 100. Examples of such polymers may include poly(2-(2′-ethylhexyloxy)-5-(2″-((2′″,7′″-di-t-butyl)-9″,9′″-spirobifluorenyl)-1,4-phenylenevinylene)), poly(2-(2′-methoxy)-5-(2″-((2′″,7′″-di-t-butyl)-9″,9′″,spirobifluorenyl)-1,4-phenylenevinylene), poly(2-(2′-ethylhexyloxy)-5-(2″-(9″,9′″-spirobifluorenyl)-1,4-phenylenevinylene) and poly(2-(2″,7″-di-t-butyl)-9′,9″-spirobifluorenyl-1,4-phenylenevinylene).

The electroluminescent polymer of Formula 1 according to the present invention may be used as light emitting layers, hole-transporting layers or electron-transport layers in organic electroluminescent devices.

An example of the process for manufacturing the organic electroluminescent devices using the electroluminescent polymer according to the present invention is as follows.

Material for anode is coated on a surface of a substrate. As for a substrate, the material therefor is well known in the relevant arts. A glass substrate or a transparent plastic substrate having excellent transparency, surface smoothness, easiness of handling and water-poof property may be used with preference. As the material for anode, indium tin oxide (ITO), tin oxide (SnO₂), zinc oxide (ZnO) which are excellent in transparency and electrical conductivity may be used. As the material for cathode, there may be employed Li, Ca, Mg, Al, Al;Li, Mg:Ag and the like, which have a low work function.

The organic electroluminescent device may further comprise a hole-transport layer and/or an electron-transport layer in addition to the general configuration of anode/light emitting layer/cathode. The light emitting layer may be formed by spin coating and its thickness is preferably 10 to 10,000 Å. The hole-transport layer may be formed on the anode, for example by a vacuum vapor deposition or spin coating. The electron-transport layer may be formed on the light emitting layer by a vacuum vapor deposition or spin coating prior to forming the cathode. The electron-transport layer may be made of materials commonly used for electron-transport layers. Although the hole-transport layer and the electron-transport layer may be formed using materials well known in the relevant arts, there may be used the compound of Formula 1 in accordance with the present invention. Such materials for the hole-transport layer and electron-transport layer are not particularly limited but preferably, N,N′-bis(3-methylphenyl)-N,N-diphenyl-[1,1′-biphenyl]-4,4′-diamine(TPD), PEDOT:PSS (Poly(3,4-ethylenedioxy-thiophene) doped with poly(styrenesulfonic acid)), polyvinylcarbazole, doped polyaniline, doped poly(3,4-ethylene-dioxythiophene, doped polypyrrole may used as the hole-transport layer, and aluminum trihydroxyquinoline (Alq3), 1,3,4-oxadiazol derivatives, such as 2-(4-biphenylyl)-5-phenyl-1,3,4-oadiazole (PBD), quinoxaline derivatives, such as 1,3,4-tris[3-phenyl-6-trifluoromethyl]quinoxaline-2-yl)benzene (TPQ), and triazol derivatives may be used as the electron-transport layer. The electron-transport layer and hole-transport layer serve to deliver effectively the carriers, that is, electrons or holes to the light emitting polymer, thereby increasing the luminescence coupling in the light emitting polymer. Thickness of the hole-transport layer and electron-transport layer, respectively is preferably 10 to 10,000 Å. Additionally, lithium fluoride (LiF) can used as material for a hole-blocking layer. This layer improves the electron-hole balance in the electroluminescent layer by blocking holes in the electroluminescent layer.

Finally, material for cathode may be coated on the electron-transport layer or the hole-blocking layer.

The organic electroluminescent device may formed in the order of anode/hole-transport layer/light emitting layer/electron-transport layer/cathode as described above, or in the opposite order of cathode/electron-transport layer/light emitting layer/hole-transport layer/anode.

### DESCRIPTION OF THE PREFERRED EMBODIMENTS

Now, the present invention will be described in detail with reference to following examples. These examples however, are intended to illustrate the present invention and should not be construed as limiting the scope of the present invention.

### Preparation Example 1

### Preparation of Organic Electroluminescent Polymer Represented by Formula 2

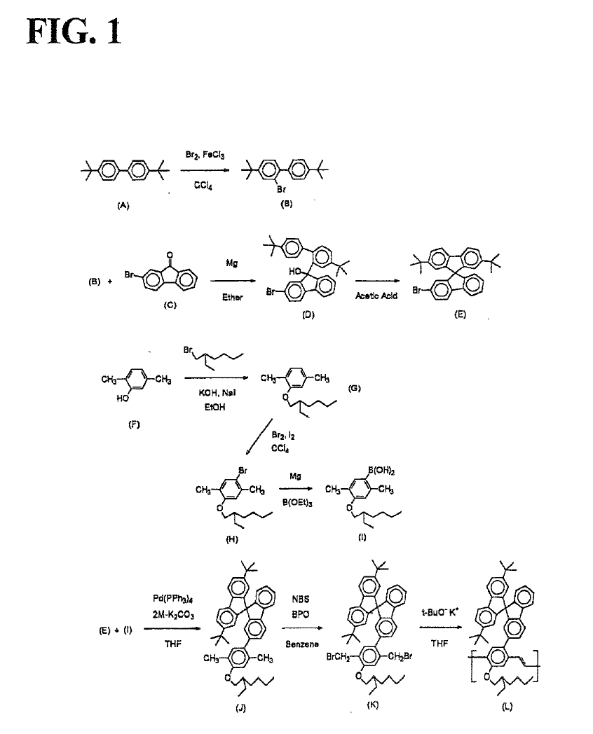

As illustrated in FIG. 1, 28.8 g of 4,4-di-t-butyl-diphenylene (A) was added to 300 ml of CCl₄. Then, 16.2 g of Br₂ and 0.13 g of FeCl₃ were added thereto. As a result of the bromination, 28.0 g of 4,4′-di-t-butyl-2-bromo-diphenylene (B) was obtained (yield: 78.7%). 15 g of the compound (B) is added dropwise to a mixture of 1.15 g of magnesium and 160 ml of ethylether and heated to form Grignard reagent Then, 10.2 g of 2-bromofluorenone (C) was added and reacted for 4 hours to form a compound (D). Thereafter, 100 ml of acetic acid was added and refluxed for 3 hours to obtain 13.6 g of compound (E) (yield: 72.1%).

100 g of 2,5-dimethylphenol (F), 169.5 g of 2-ethylhexylbromide, 57.1 g of KOH and 8.4 g of NaI were put into 400 ml of ethanol and refluxed for 60 hours to obtain 147.8 g of 2-ethylhexyl-p-xylene (G) (yield: 79.3%). 65.1 g of the compound (G) was added to 200 ml CCl₄, and brominated by adding 53. 1 g of Br₂ to obtain 79.4 g of 2-bromo-5-ethylhexyloxy-p-xylene (H) (yield: 91.5%).

30 g of 2-bromo-5-ethylhexyloxy-p-xylene (H) was added to a mixture of 2.7 g of magnesium and 180 ml of THF and reacted together to prepare Grignard Reagent. The resulting Grignard reagent was cooled to -70° C. with a mixture of dry ice and acetone, followed by addition of 24.0 g of triethylborate. The reaction mixture was stirred at room temperature for 8 hours. Then, the reaction mixture was treated with 4N HCl to obtain 22 g of a compound (I) (yield: 85%).

50 ml of THF, 38.7 ml of 2M K₂CO₃ and 0.13 g of tetrakis(triphenylphospine)palladium (Pd(PPh₃)₄) were added to 13.7 g of the compound (E) and 9.1 g of the compound (I), and the reaction was carried out for 24 hours to obtain 13.0 g of a compound (J) (yield: 72.7%). 6.0 g of the compound (J) was dissolved in 150 ml of benzene. To the resulting solution, 3.23 g of N-bromosuccinimide and 0.022 g of benzoyl peroxide (BPO) were added. After refluxing for 8 hours, the solution was separated on a column to obtain 3.5 g of compound (K) as a monomer (yield: 47.0%).

1.00 g of the compound (K) was dissolved in 22 ml of THF. To the resulting solution, 2.7 ml of 1M potassium-t-butoxide dissolved in THF, and then 70 ml of THF, were added and stirred for 2 hours at room temperature. Again, 2.7 ml of IM potassium-t-butoxide dissolved in THF was added thereto. Thereafter, the reaction was performed for 2 hours at room temperature and then for 2 hours at 50° C. to obtain a polymer (L) represented by Formula 2. The polymer of Formula 2 was purified by carrying out a precipitaion method using tetrahydrofuran as a solvent and methanol as a non-solvent. The precipitation was carried out twice with the ratio of the solvent and non-solvent being initially 1:7 and then 1:5. The product was dried in a vacuum oven and used for manufacturing an electroluminescent device.

The polymers obtained as above from 4 different experiments were measured for their weight average molecular weights and results are shown in Table 1 below.

TABLE 1

| | Exp.1 | Exp.2 | Exp.3 | Exp.4 |
|---|---|---|---|---|
| Mw | 2,593,785 | 2,380,973 | 670,038 | 1,073,890 |

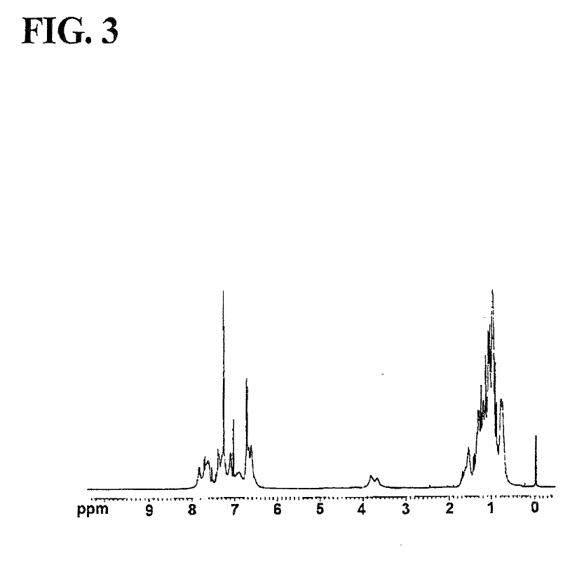

The structure of the polymer of formula 2 was examined using 1H-NMR and the results are shown in FIG. 3. ¹H-NMR (CDCl₃): δ6.6-7.7 (aromatic C—H and vinyl C-H, 17H), δ3.6-3.9 (—O—CH_{2, 2}H), δ0.7-1.5 (CH₂ and CH₃, 33H).

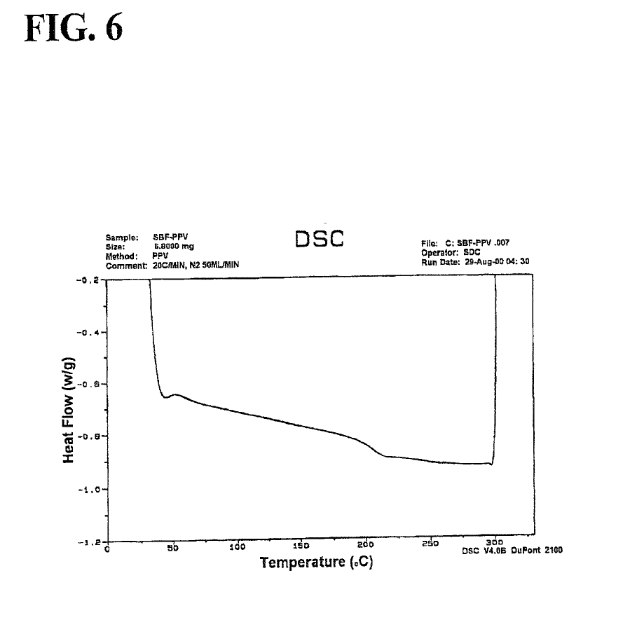

Thermal properties of the compound of formula 2 was examined using a differential scanning calorimetry (DSC) analysis and the results are shown in FIG. 6. The polymer has a glass transition temperature of 215° C., which indicates good thermal properties.

### Preparation Example 2

### Preparation of Organic Electroluminescent Copolymer Represented by Formula 3.

8.0 g of compound (K) was dissolved in 1000 ml of 1,4-dioxane with 600 ml of water. To the resulting solution, 14.5g of calcium carbonate was added. After refluxing for 24 hours, the solution was cooled to room temperature, and treated with 2N HCl aqueous solution, and separated on a column to obtain 5.7 g of compound-(M).

Compound (M):(1,4-Bis(hydroxymethyl)-2-(2′-ethylhexyloxy)-5-(2″-((2′″, 7′″-di-t-butyl)-9″,9′″-spirobifluorenyl)) benzene)

120 ml of methylene chloride and 1.3 g of pyridine were added to 5.7 g of compound (M), and the solution was cooled to 0° C. 4.9 g of thionyl chloride was slowly added and the solution was stirred for 8 hours. The resulting mixture was treated with 10% sodium bicarbonate aqueous solution and separated on a column to obtain 2.3 g of compound (N).

Compound (N): (1,4-Bis(chlomomethyl)-2-(2′-ethylhexyloxy)-5-(2″-((2′″,7′″-di-t-butyl)-9″,9′″-spirobifluorenyl)) benzene)

2-Methoxy,5-(2′-ethyl-hexyloxy)-p-phenylenevinylene(O) was synthesized as described in U.S. Pat. No. 5,189,136 (1993).

0.3 g of the compound (N) and 0.14g of compound (O) were dissolved in 7.0 ml of THF. To the resulting solution, 3.3 ml of 1M potassium-t-butoxide dissolved in THF, and then 46 ml of THF were added. Thereafter, the reaction was performed for 2 hours at room temperature and then for 2 hours at 50° C. to obtain a polymer (P) represented by Formula 3.

The polymer of Formula 3 was purified by carrying out a precipitation method using tetrahydrofuran as a solvent and methanol as a non-solvent. The precipitation was carried out twice with the ratio of the solvent and non-solvent being initially 1:7 and then 1:5. The product was dried in a vacuum oven and used for manufacturing an electroluminescent device. The polymer obtained as above was measured for its weight average molecular weight and the result was 868,298.

### EXAMPLE 1

### Properties Assessment of the Organic Electroluminescent Polymers:

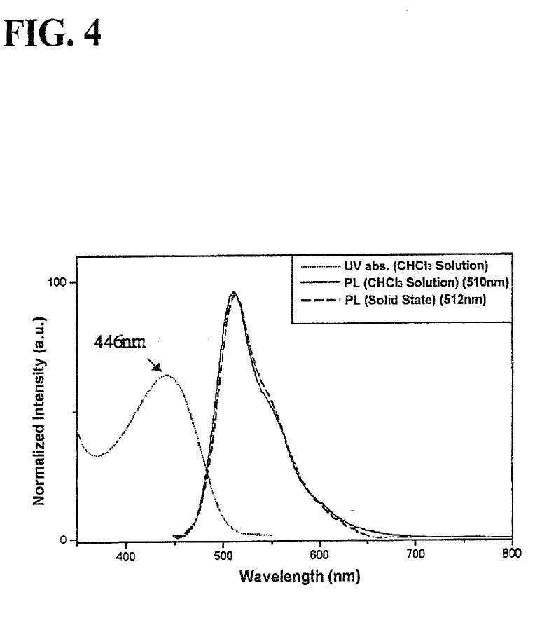

The organic electroluminescent polymer prepared from Preparation Example 1 was examined using UV-absorption spectrum and PL spectrum and the results are shown in FIG. 4. The maximum UV absorption peak was observed at 446 nm. The maximum peak of the PL spectrum in a solution of chloroform was observed at 510 nm, shoulder was observed at 560 nm. In the case of a thin film prepared by spin coating, the maximum peak of the PL spectrum was observed at 512 nm. Shifting of the maximum peak in the film to the red region by 2 nm compared to the solution indicates that the bulky substituents prevent molecules from π-stacking with each other, thereby prohibiting the formation of eximer. Therefore, the polymer was demonstrated to be a material having high luminous efficiency.

### EXAMPLE 2

### Preparation of Electroluminescent Device

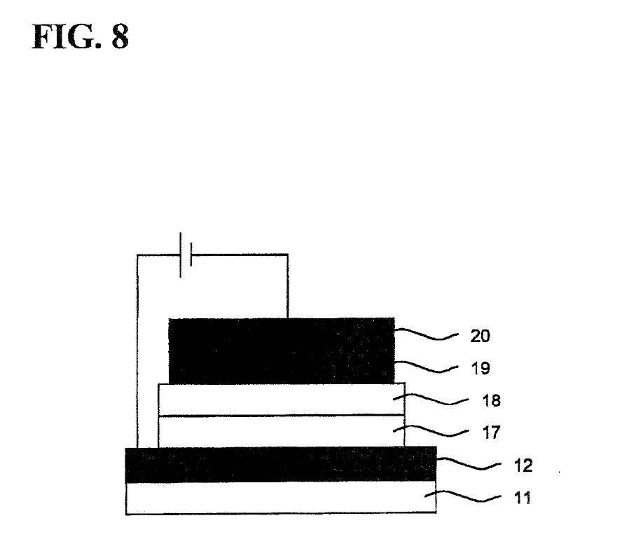

A first layer 17 (Poly(3,4-ethylenedioxy-thiophene) doped with poly(styrenesulfonic acid); PEDOT:PSS) was formed to a thickness of about 300 Å on a glass substrate 11 having a ITO coating 12 thereon, which had been previously patterned and dried in a vacuum oven at 100° C. for 1 hour. Next, the compound of Formula 2 dissolved in chlorobenzene was spin-coated on the first layer 17 to a thickness of 900 Å to form a light emitting layer 18 and again dried in a vacuum oven at 100° C. for 1 hour. On the light emitting layer 18, LiF was vacuum vapor deposited to form a 20 Å layer 19 and then aluminium was vacuum vapor deposited to a thickness of 700 Å to form a cathode 20. Thus, an organic electroluminescent device having a structure shown in FIG. 8 was completed.

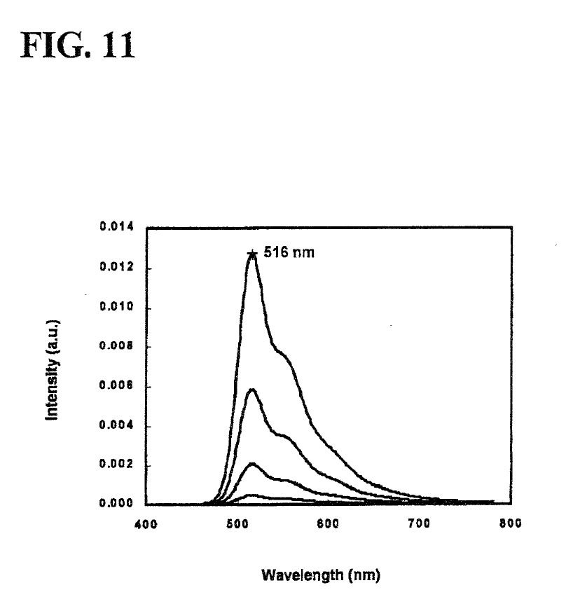

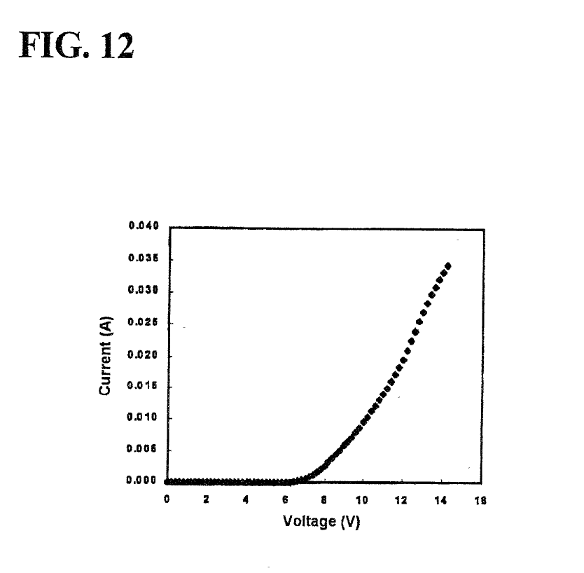

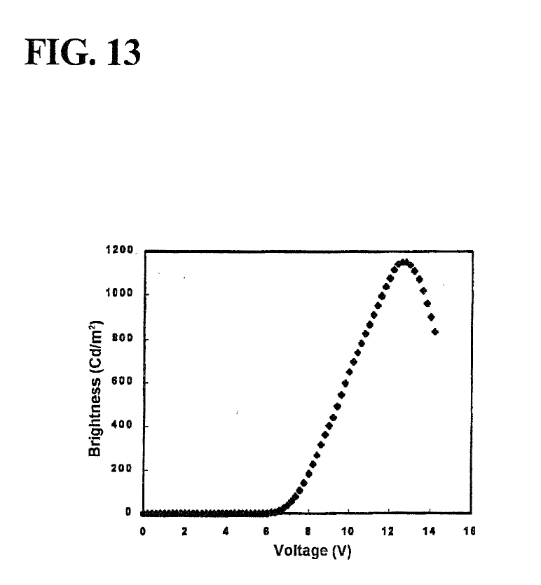

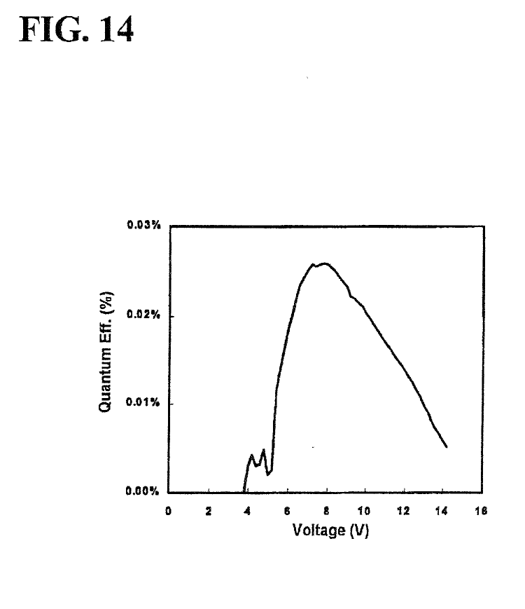

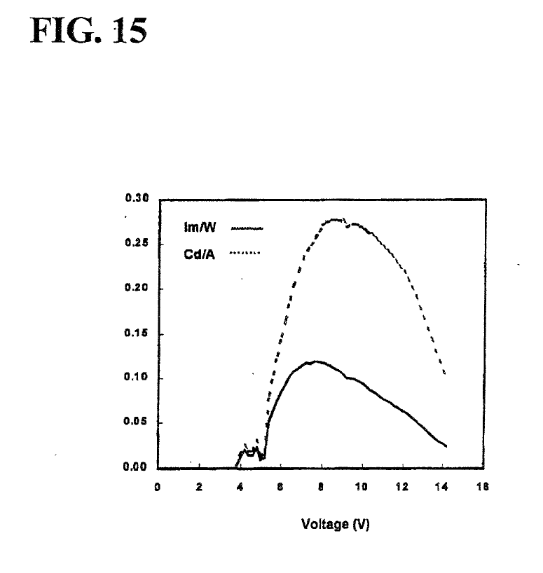

The organic electroluminescent device thusly obtained was examined for EL spectrum, current-voltage, brightness-voltage, luminous efficiency and color properties and results are shown in FIGS. 11 to 15.

TABLE 2

| Test item | | Result |
|---|---|---|
| Turn-on voltage (V) | | 6.0 |
| Maximum brightness (cd/m²) | | 1,142 |
| Efficiency | lm/W | 0.12 |
| | cd/A | 0.28 |
| Color | | Green (516 nm) |
| CIE Coordinate | X | 0.326 |
| | Y | 0.608 |

As seen from the results of the Table 2 and FIGS. 11 to 15, it is found that the polymer of Formula 2 emits green light when driving the electroluminescent devices and exhibits a maximum peak equivalent to that of the PL spectrum. Also, the green color has a color coordinate much closer to the NTSC green than the conventional green organic electroluminescent materials. Therefore, it is proved that the polymer of Formula 2 according to the present invention has an advantage in terms of color purity for realization of full-color display.

### EXAMPLE 3

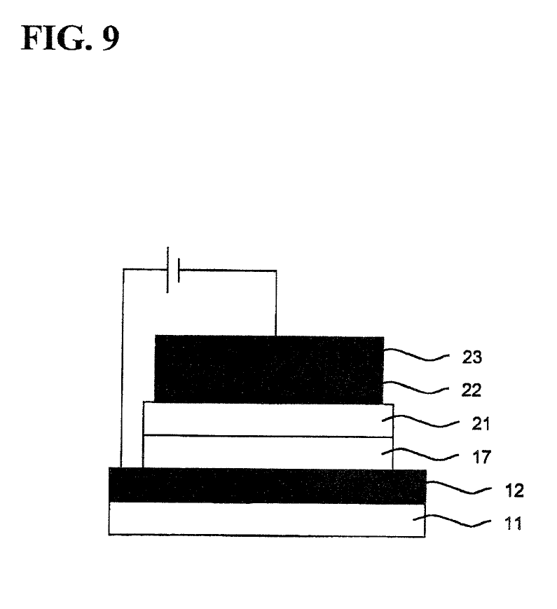

A first layer 17 (PEDOT:PSS) was formed to a thickness of about 500 Å on a glass substrate 11 having a ITO coating 12 thereon, which had been previously patterned and dried in a vacuum oven at 100° C. for 1 hour. Next, the compound of Formula 2 dissolved in toluene was spin-coated on the first layer 17 to a thickness of 600 Å to form a light emitting layer 21 and again dried in a vacuum oven at 100° C. for 1 hour. On the light emitting layer 21, Ca was vacuum vapor deposited to form a 500 Å layer 22 and then aluminium was vacuum vapor deposited to a thickness of 1500 Å to form a cathode 23. Thus, an organic electroluminescent device having a structure shown in FIG. 9 was completed.

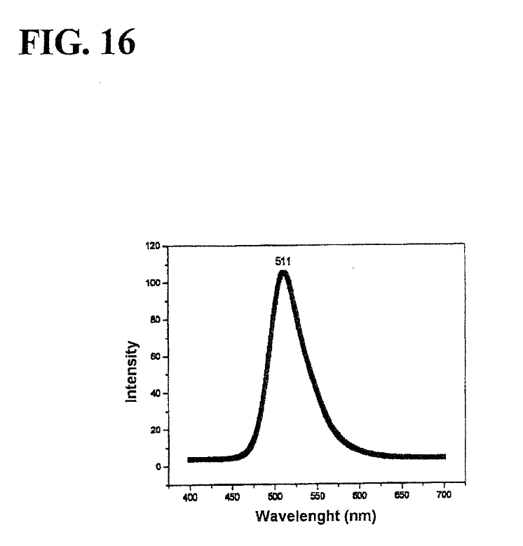

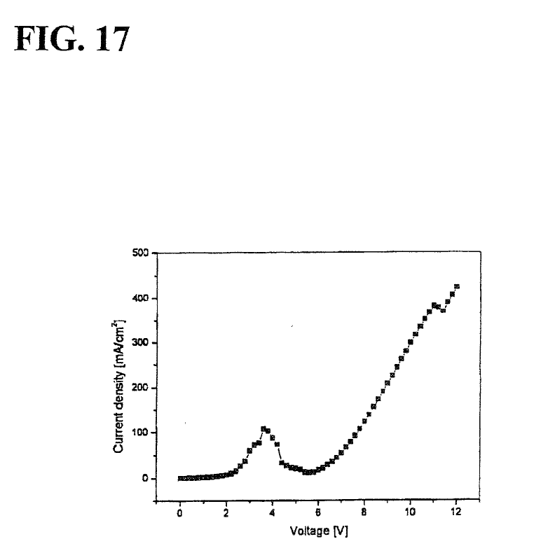

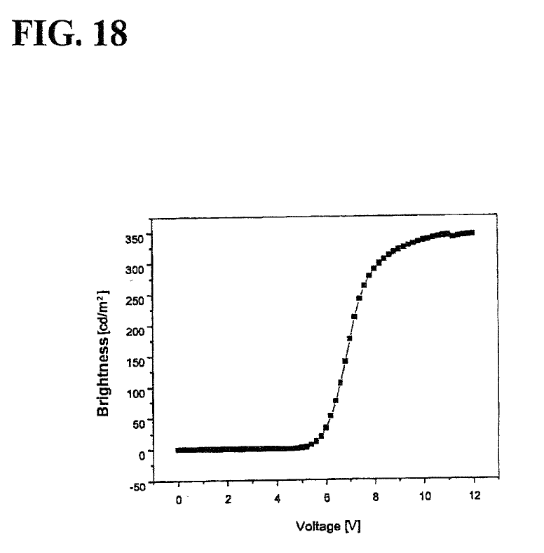

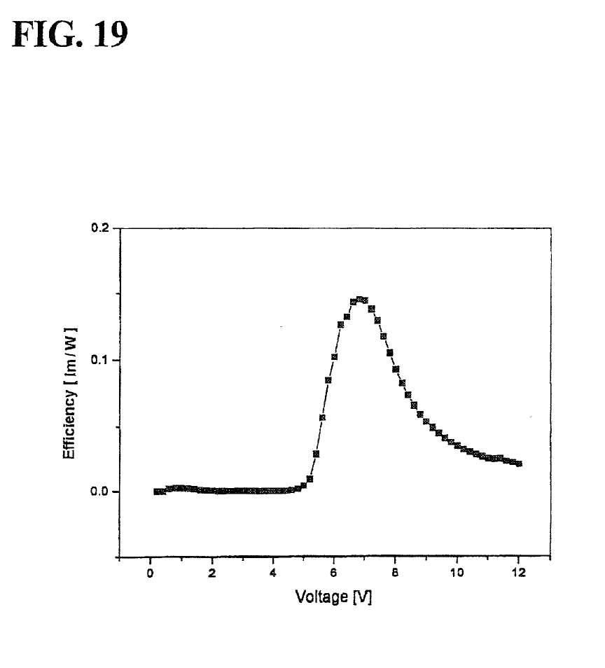

The organic electroluminescent device thusly obtained was examined for EL spectrum, current-voltage, brightness-voltage, luminous efficiency and color properties and the results are shown in FIGS. 16 to 19.

TABLE 3

| Test item | | Result |
|---|---|---|
| Turn-on vokage (V) | | 5.5 |
| Maximum brightness (cd/m²) | | 350 |
| Efficiency | lm/W | 0.15 |
| | cd/A | 0.28 |

| | |
|---|---|
| Color | Green (511 nm) |

As seen from the results of the Table 3 and FIGS. 16 to 19, the turn-on voltage was slightly reduced in this Example as compared to the results of the Example 2. This is believed to be due to calcium used as the cathode material in place of the aluminum. Further, the maximum brightness was considerably reduced compared to the Example 2. This is also believed to be due to calcium's poor stability, thereby inducing the high brightness condition unstable. The rest of the results were similar to those of the Example 2.

### EXAMPLE 4

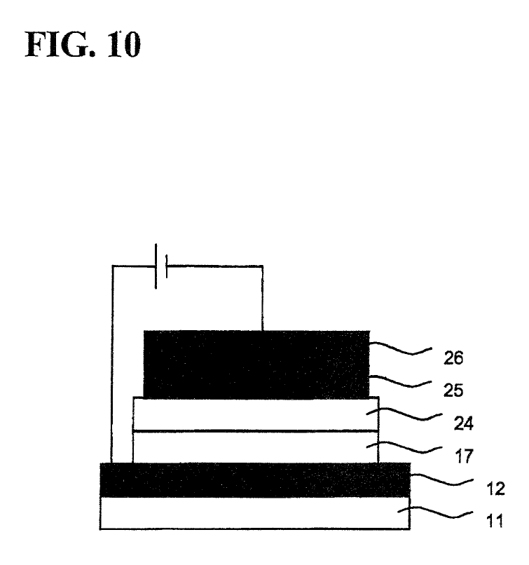

A first layer 17 (Poly(3,4-ethylenedioxy-thiophene) doped with poly(styrenesulfonic acid); PEDOT:PSS) was formed to a thickness of about 300 Å on a glass substrate 11 having a ITO coating 12 thereon, which had been previously patterned and dried in a vacuum oven at 100° C. for 1 hour. Next, the compound of Formula 3 dissolved in chlorobenzene was spin-coated on the first layer 17 to a thickness of 850 Å to form a light emitting layer 24 and again dried in a vacuum oven at 100° C. for 1 hour. On the light emitting layer 24, LiF was vacuum vapor deposited to form a 20 Å layer 25 and then aluminium was vacuum vapor deposited to a thickness of 700 Å to form a cathode 26. Thus, an organic electroluminescent device having a structure shown in FIG. 10 was completed.

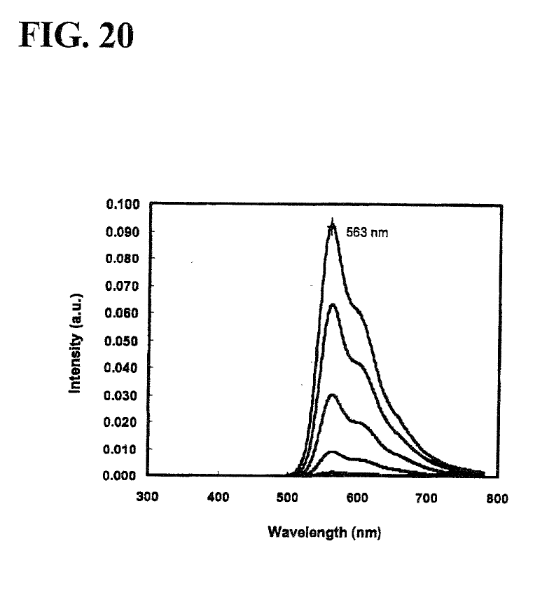

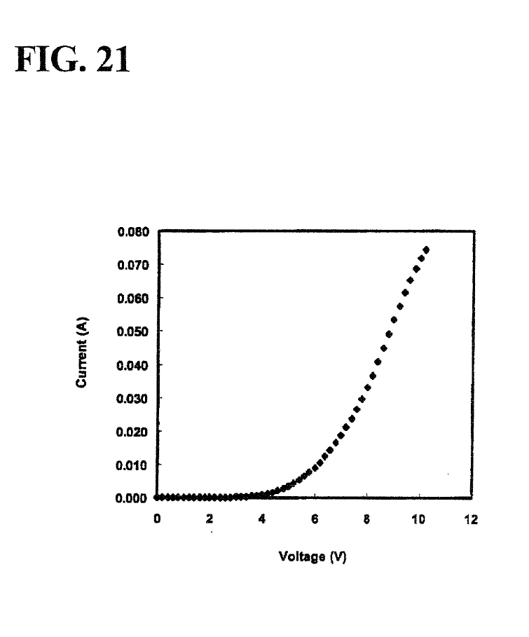

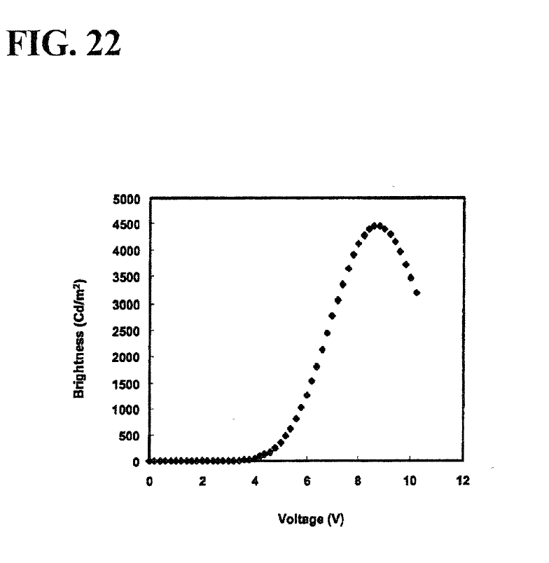

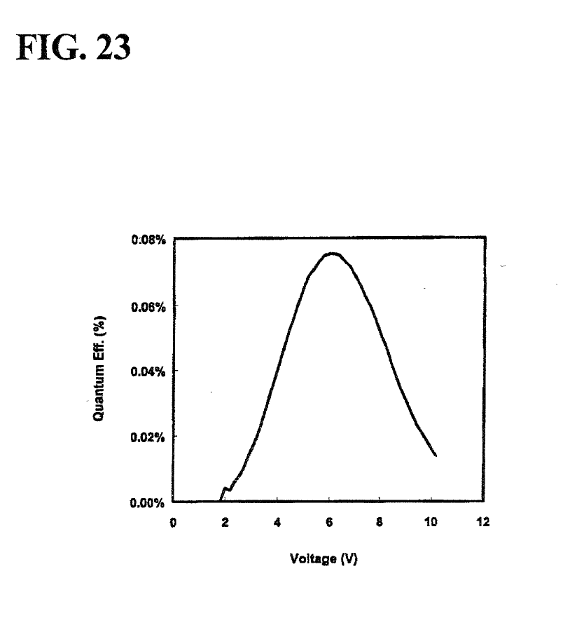

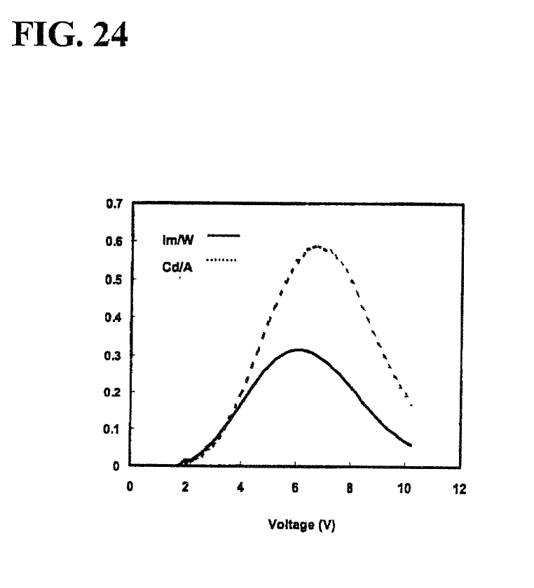

The organic electroluminescent device thusly obtained was examined for EL spectrum, current-voltage, brightness-voltage, luminous efficiency and color properties and results are shown in FIGS. 20 to 24.

TABLE 4

| Test item | | Result |
|---|---|---|
| Turn-on voltage (V) | | 3.0 |
| Maximum brightness (cd/m²) | | 4,448 |
| Efficiency | lm/W | 0.32 |
| | cd/A | 0.59 |
| Color | | Yellow (563 nm) |
| CIE Coordinate | X | 0.502 |
| | Y | 0.493 |

As seen from the results of the Table 4 and FIGS. 20 to 24, it is found that the polymer of Formula 3 emits yellow light when driving the electroluminescent devices and overall performance—efficiency, turn-on voltage, brightness, etc—was highly improved as compared with polymer (L) and MEH-PPV.

As described above, the organic electroluminescent polymers have advantages of both low molecular weight materials and high molecular weight materials and a proper level of electrical conductivity while being capable of minimizing the interactions between excitons. Therefore, they can provide an excellent luminous efficiency and improve the stability of the electroluminescent device. Also, they can prevent the deterioration of the electroluminescent device due to the heat generated when driving the device. In addition, either a vacuum vapor deposition or spin coating may be used to form a light emitting layer, hole-transport layer or electron-transport layer using the organic electroluminescent polymer according to the present invention, thereby increasing convenience to the user.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

What is claimed is:

1. An organic electroluminescent polymer represented by the following Formula 1: 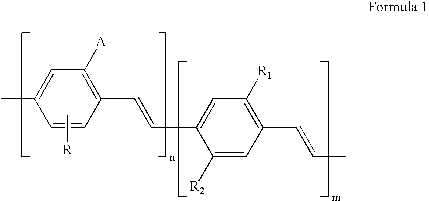
wherein both A and B are 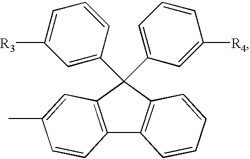
or any one of A and B is 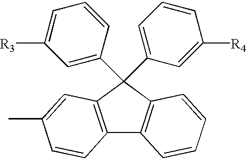
and the other is R₅; R₃, R₄ and R₅ are independently selected from the group consisting of hydrogen, phenoxy group substituted with C₁₋₂₀ alkyl group, C₁₋₂₀ alkoxy group, C₁₋₂₀ alkoxyphenyl group, C₁₋₂₀ alkyl group and C₃₋₂₁ ω-methoxy poly ethylene oxide group; m is an integer of 0 to 50,000; n is an integer of 1 to 100,000, with the proviso that n is greater than m.

2. The organic electroluminescent polymer according to claim 1, wherein B is hydrogen and A is not hydrogen.

3. The organic electroluminescent polymer according to claim 1, wherein neither A nor B is hydrogen.

4. The organic electroluminescent polymer according to claim 3, wherein A is 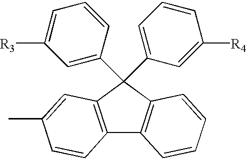
in which both R₃ and R₄ are a t-butyl group, and B is a 2-ethylhexyloxy group.

5. An electroluminescent device in which the organic electroluminescent polymer according to claim 1 is used as a light emitting layer, hole-transport layer or electron-transport layer.

6. The electroluminescent device according to claim 5, wherein the device is configured to have a structure of anode/light emitting layer/cathode, anode/hole-transport layer/light emitting layer/cathode, or anode/hole-transport layer/light emitting layer/electron-transport layer/cathode.
